(19) United States
(12) Patent Application Publication
(10) Pub. No.: US 2025/0313026 A1
(43) Pub. Date: Oct. 9, 2025

(54) METHOD FOR DETECTING MALFUNCTIONAL NOZZLES IN A PRINTING HEAD AND PRINTING DEVICE

(71) Applicant: BOBST MEX SA, Mex (CH)

(72) Inventor: Francisco Javier PEREZ GELLIDA, Nyon (CH)

(73) Assignee: BOBST MEX SA, Mex (CH)

(21) Appl. No.: 18/864,993

(22) PCT Filed: Aug. 10, 2023
(86) PCT No.: PCT/EP2023/072192

§ 371 Date: Nov. 12, 2024

(30) Foreign Application Priority Data
Aug. 10, 2022 (EP) 22189757.2

(51) Int. Cl. B41J 29/393; B41J 2/165; B41J 11/00; G06K 15/02

(52) U.S. Cl. CPC B41J 29/393; B41J 2/16579; B41J 11/0095; G06K 15/027; B41J 2029/3935; G06K 2215/101

(57) ABSTRACT

A method for detecting malfunctional nozzles (26) in a printing head (12) of a printing device (10) is provided. The method comprises printing a test pattern (28) with the printing head (12) on a print medium (22), wherein the test pattern (28) comprises at least one continuously and preferably uniformly printed area (30, 32, 34,36), wherein the area (30, 32, 34, 36) extends along the nozzles (26) to be inspected, inspecting the test pattern (28) and indicating that a nozzle (26) is malfunctional if a vertical line (38) is detected in the test pattern (28). Furthermore, a printing device is provided.

The invention refers to a method for detecting and compensating malfunctional nozzles in a printing head of a printing device and a printing device.

Malfunctional nozzles in a printing head of a printing device may cause visible defects in a print. It is thus necessary to detect malfunctional nozzles.

It is known how to evaluate print quality degradation by printing a test pattern, wherein each nozzle prints an individual mark that is assigned to the respective nozzle and the individual marks are inspected.

However, this method is rather elaborate, providing the exact identification of each malfunctional nozzle.

It is thus an object of the invention to detect the presence of malfunctional nozzles in a simple manner.

This object is achieved by a method for detecting and compensating malfunctional nozzles in a printing head of a printing device, wherein the method comprises printing a test pattern with the printing head on a print medium, wherein the test pattern comprises at least one continuously and preferably uniformly printed area, wherein the area extends along the nozzles to be inspected. The method further comprises inspecting the test pattern and indicating that a nozzle is malfunctional if a vertical line is detected in the test pattern. A severity of the malfunction is indicated based on a degree of visibility of the vertical line and based on the severity of the malfunction of a nozzle, it is decided if a compensation of the malfunction is required. A further test pattern different from the first test pattern is printed, wherein the exact location of the malfunctional nozzle is determined, and the nozzles adjacent to the malfunctional nozzle are used to compensate the malfunction.

Uniformly should be understood as being the same print density per printed area. Nevertheless. Uniformly in the meaning of the present invention also includes uniform densities over at least three nozzles, and continuously printed areas with a variation in print density.

The inventive method has the advantage that the detection of a malfunctional nozzle and the approximate location of the malfunctional nozzle can happen quickly and with little effort.

The core idea of the invention is to focus on an overall print rather than on individual marks printed by the individual nozzles first before the decision to compensate nozzles.

Another advantage of the inventive method is that only such malfunctions are detected which cause a visible defect in the print. Like this it is for example possible to detect malfunctions only for visible defects, whereby visible could mean at a certain predefined threshold. Visible could for example also be defined as defects visible by the human eye at a reasonable distance of for example 20 cm. Malfunctions that are not visible are thus ignored. Thereby, unnecessary maintenance of the printing head is inhibited.

Malfunctions of nozzles may occur due to partial or total clogging of the nozzle, or due to inaccuracy in the production process.

According to one aspect of the invention, the severity of the malfunction is indicated based on a degree of visibility of the vertical line. Thereby, malfunctions can be categorized according to their effect on the print.

For example, it is decided based on the severity of the malfunction of a nozzle if a compensation of the malfunction is required. Thereby, maintenance can be postponed or omitted if the malfunction is marginal.

The test pattern for example comprises at least two continuously printed areas being located subsequently to each other with respect to a travel direction of the print medium, wherein the test pattern is printed with a different coverage in the different areas. In the areas which are printed with a higher coverage, the vertical lines caused by malfunctional nozzles are more visible due to a higher contrast. Thus, printing a test pattern with areas of different coverage contributes to a reliable detection of vertical lines and a better determination of the severity of the malfunction.

An approximate location of the malfunctional nozzle can be indicated based on the location of the vertical line. It is thus easy to estimate in which area of the printing head the malfunctional nozzle lies.

After indicating an approximate location of the malfunctional nozzle, a further test pattern is analyzed which is different from the first test pattern, wherein the exact location of the malfunctional nozzle is determined based on the further test pattern. The method for detecting the exact location of a malfunctional nozzle is thus a two-step procedure. Thereby, the method for detecting the exact location of a malfunctional nozzle is in whole less elaborate than the known methods. In particular, accurate inspection is only required in the area where the malfunctional nozzle approximately lies.

In the further test pattern, the printed sections are distinguishable and can be assigned to a specific nozzle. Thereby, a detected malfunction can be ascribed to a specific nozzle.

According to a preferred embodiment, the nozzles adjacent to the malfunctional nozzle are used to compensate the malfunction. Thereby, maintenance of the printing head can be avoided and the quality of the print can be improved in a simple manner.

The object of the invention is further achieved by a printing device configured to perform the inventive method with at least one printing head comprising a plurality of nozzles, a scanner for scanning the image printed by the printing device and a control unit configured to inspect the scanned image and indicate a malfunctional nozzle. As already described with respect to the inventive method, the printing device provides an easy detection of a malfunctional nozzle as well as an easy indication of the approximate location of the malfunctional nozzle.

Further features and advantages of the invention can be derived from the following description and from the enclosed drawings. In the drawings

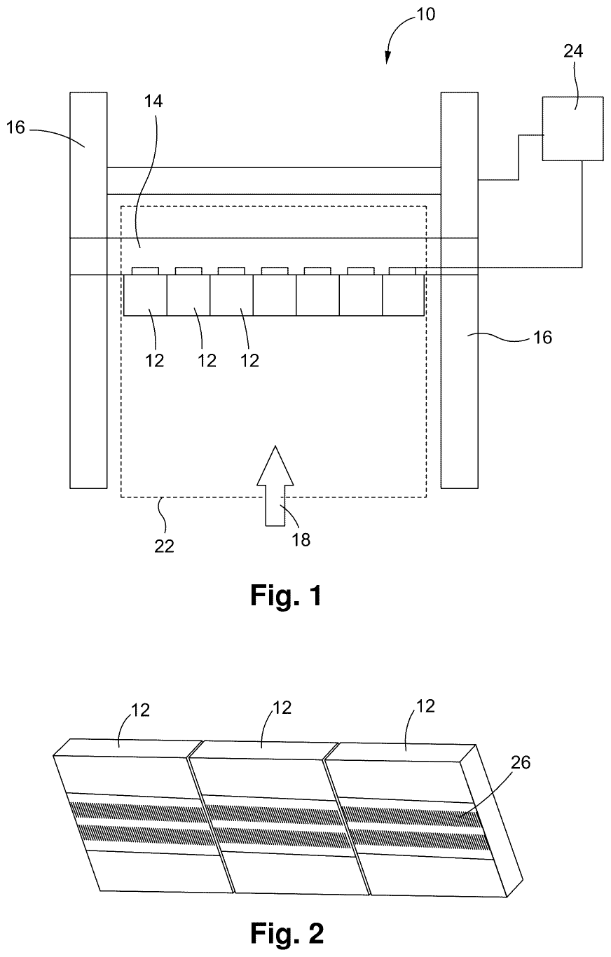

FIG. 1 schematically shows an inventive printing device,

FIG. 2 show printing heads of a printing device,

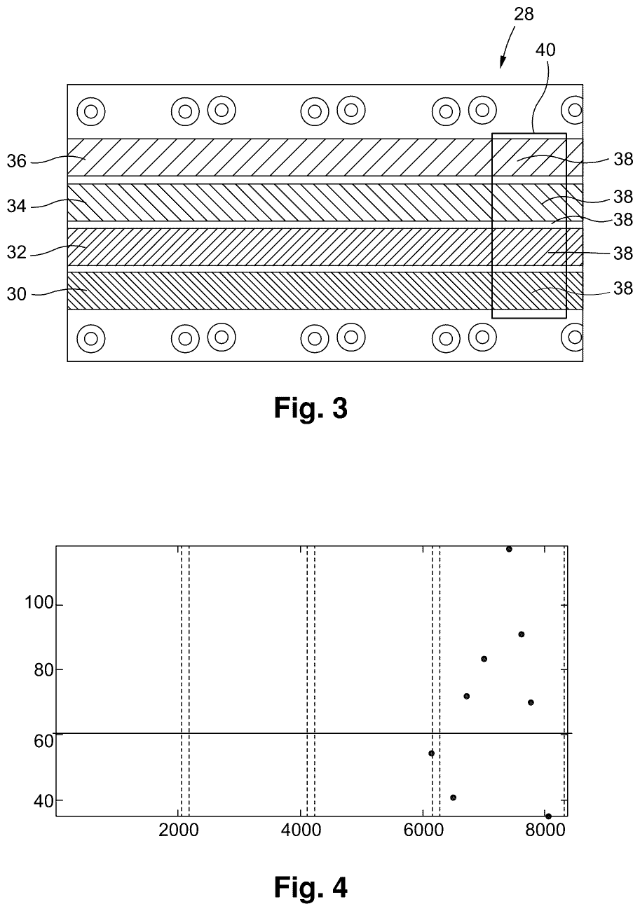

FIG. 3 shows a test pattern printed by a printing device,

FIG. 4 shows a diagram visualizing the severity of a detected malfunction, and,

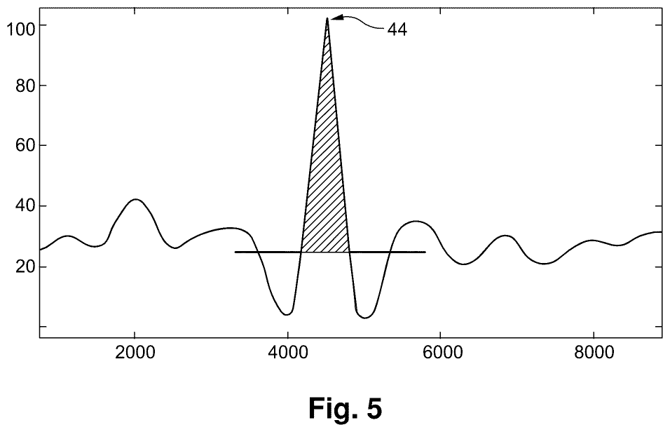

FIG. 5 shows how the severity of a Bad Jet is calculated

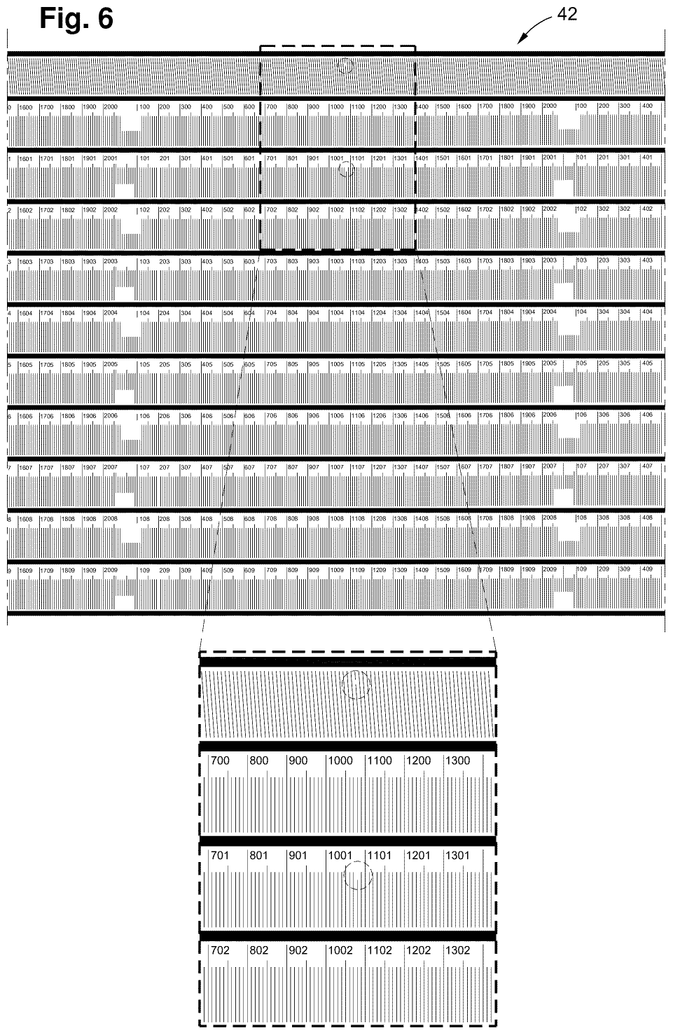

FIG. 6 shows a further test pattern.

FIG. 1 shows a printing device 10 comprising a plurality of printing heads 12 in a schematic view. In the depicted embodiment, seven printing heads 12 are shown, however, the number of printing heads 12 may vary.

The printing heads 12 are two-dimensional printing heads.

The printing device 10 is an ink jet printing device, in particular a digital printer.

The printing heads 12 are attached to a bar 14 extending transverse to an advance direction of the printing device 10.

The bar 14 is attached to a machine frame 16 of the printing device 10.

The advance direction corresponds to a travel direction of a print medium 22 and is indicated in FIG. 1 by arrow 18.

All the printing heads 12 attached to one bar 14 are configured to print a single colour. Thus, for printing different colours the printing device 10 comprises several printing bars 14 with attached printing heads 12 that are arranged along the advance direction. For reasons of simplicity, only one printing bar 14 is depicted in FIG. 1.

FIG. 2 shows three printing heads 12 arranged in a row in a view from below such that the nozzles 26 of the printing heads 12 are visible.

After printing a scanner can be used to either fully check the whole plot or to make partial scans to cover the whole width of the plot. The scanner can be for example an offline scanner and/or an inline scanner, for example a camera scanner.

Each of the printing heads 12 comprises a plurality of nozzles 26.

It may happen that some of the nozzles 26 are malfunctional because of a manufacturing defect or because the nozzles 26 get clogged after some time in use.

Thus, the print heads 12 have to be inspected in order to detect malfunctional nozzles 26.

The inspection takes place for example after the installation of a printing head 12 and is repeated in regular intervals, or if a printing artifact shows up.

According to the inventive method, malfunctional nozzles 26 in a printing head 12 can be detected by analysing an image printed by the printing device 10.

For this purpose, a test pattern 28, which is visualized in FIG. 3, is printed with the printing heads 12 on a print medium 22. In particular, the pattern 28 depicted in FIG. 3 is printed by four adjacent printing heads 12.

In the depicted embodiment, the test pattern 28 comprises four continuously printed areas 30, 32, 34, 36 wherein the areas 30, 32, 34, 36 extends along the nozzles 26 to be inspected.

The areas 30, 32, 34, 36 are located subsequently to each other with respect to the travel direction of the print medium 22.

The test pattern 28 is printed with a different coverage in the different areas 30, 32, 34, 36.

For example, the area 30 has a coverage of 50%, the area 32 has a coverage of 40%, the area 34 has a coverage of 30% and the area 36 has a coverage of 20%.

Then, the test pattern 28 is inspected. In particular, the test pattern 28 is scanned by the scanner 20 and inspected by the control unit 24.

If a vertical line 38 is detected in the test pattern 28, it is indicated that a nozzle 26 is malfunctional.

In the test pattern 28 depicted in FIG. 3, several vertical lines 38 are visible in the area 40.

The vertical lines 38 are either lighter or darker lines, as due to the malfunction of the nozzle 26, the ability to dispense ink through the malfunctional nozzle 26 is impeded or deviated on an already printed area.

The severity of the malfunction is indicated based on a degree of visibility of the vertical line 38. This can be done by a scanner or a camera, preferably with a sensibility of a human eye or a bit higher.

An approximate location of the malfunctional nozzle 26 is indicated based on the location of the vertical line 38.

FIG. 4 shows a diagram in which the approximate location of the malfunctional nozzles 26 as well as the severity of the malfunction are visualized.

The position of a malfunctional nozzles 26 with respect to a width of the print medium 22 is indicated in 1200 dpi.

For example, the approximate location of a malfunctional nozzle 26 is determined by means of an algorithm.

In the embodiment, the severity of a vertical line 38 is the area of the density peak generated by vertical line 38 in px_1200 dpi*Delta_CIE_Lab

In FIG. 5 the calculation of the severity of a Bad Jet is shown. The graph shows the density over the width of a printed area. A density peak is visualized in the graph by a local peak 44 and the severity is calculated as the area of the resulting triangle above a base line 46: ½*b*h.

“h” corresponds to the maximum local density change (Units: Delta_CIE_Lab) and “b” to the width of the triangle (Units: px_1200 dpi), referred to the baseline 46. The baseline 46 corresponds to the local median around the peak (+/−20 px_1200 dpi).

Based on the severity of the malfunction of a nozzle 26, it is decided if a compensation of the malfunction is required.

For example, a compensation is required if the area of the vertical line 38 is larger than 50 px_1200 dpi*Delta_CIE_Lab.

However, the area of the vertical line 38 also depends on the printing medium, more particularly on the ink absorption and spreading. Thus, in different embodiments, the threshold value can be different.

If the visibility of the vertical line 38 is below the threshold value, no compensation is required.

For example, the nozzles 26 adjacent to a malfunctional nozzle 26 are used to compensate the malfunction.

Therefore, it has to be determined exactly which nozzle 26 has a malfunction.

For this purpose, a further test pattern 42 is printed which is different from the first test pattern 28, wherein the exact location of a malfunctional nozzle 26 is determined based on the further test pattern 42.

The further test pattern 42 is depicted in FIG. 4. In the further test pattern, the printed sections are distinguishable and can be assigned to a specific nozzle 26. In particular, each nozzle 26 of the printing head 12 printed a line in the test pattern 42.

To better distinguish the lines printed by each nozzle 26, the lines are printed in different rows, wherein in each row, every tenth nozzle 26 is visualized.

In the test pattern 42 depicted in FIG. 6, one of the printed lines is defect, in particular the line which is assigned to nozzle number 1081.

By knowing the exact location of the malfunctional nozzle 26, an effective compensation can be achieved.

In the example a nozzle is detected which is either not (sufficiently) printing or is deflected. Such a malfunction could lead to a vertical line in the test pattern due to missing print. The invention also includes the detection of other defects, for example a nozzle which prints with too big drops. For such a defect a denser line might be detected in the test pattern. Many other possibilities to detect different defects are possible and known by the person skilled in the art etc.

1. A method for detecting and compensating malfunctional nozzles in a printing head of a printing device, the method comprising:
printing a test pattern with the printing head on a print medium, wherein the test pattern comprises at least one continuously and preferably uniformly printed area, wherein the area extends along the nozzles to be inspected,
inspecting the test pattern,
indicating that a nozzle is malfunctional if a vertical line is detected in the test pattern,
a severity of the malfunction is indicated based on a degree of visibility of the vertical line and based on the severity of the malfunction of a nozzle, it is decided if a compensation of the malfunction is required,
printing a further test pattern different from the test pattern, wherein an exact location of the malfunctional nozzle is determined, and
using the nozzles adjacent to the malfunctional nozzle to compensate the malfunction.

2. The method according to claim 1, wherein the degree of visibility corresponds to the visibility by the human eye at a reasonable distance of 20 cm.

3. The method according to claim 1, wherein the test pattern comprises at least two, more preferably at least four continuously and uniformly printed areas being located subsequently to each other with respect to a travel direction of the print medium, wherein the test pattern is printed with a different coverage in the different areas.

4. The method according to claim 1, wherein an approximate location of the malfunctional nozzle is indicated based on the location of the vertical line.

5. A printing device configured to perform the method according to claim 1, with at least one printing head comprising a plurality of nozzles, a scanner for scanning an image printed by the printing device and a control unit configured to inspect the scanned image and indicate a malfunctional nozzle.
